(19) United States
(12) Patent Application Publication
(10) Pub. No.: US 2014/0287111 A1
(43) Pub. Date: Sep. 25, 2014

(54) USE OF ULTRASONIC ENERGY IN THE PRODUCTION OF NUTRITIONAL POWDERS

(71) Applicants: Gary M. Gordon, Plain City, OH (US); Adam S. Milliken, Columbus, OH (US)

(72) Inventors: Gary M. Gordon, Plain City, OH (US); Adam S. Milliken, Columbus, OH (US)

(73) Assignee: ABBOTT LABORATORIES, ABBOTT PARK, IL (US)

(21) Appl. No.: 14/238,807

(22) PCT Filed: Aug. 13, 2012
(86) PCT No.: PCT/US12/50549

§ 371 Date: Jun. 4, 2014

Related U.S. Application Data
(60) Provisional application No. 61/524,099, filed on Aug. 16, 2011.

(51) Int. Cl. A23L 1/025; A23L 1/29

(52) U.S. Cl. CPC A23L 1/0252; A23L 1/296
USPC 426/238; 426/656

(57) ABSTRACT

Disclosed are ultrasonically-produced nutritional powders and methods of manufacturing the nutritional powders, including ultrasonically-produced infant nutritional powders and ultrasonically-produced adult nutritional powders.

### FIELD OF THE DISCLOSURE

The present disclosure relates to ultrasonically-produced nutritional powders and methods for manufacturing the nutritional powders. More particularly, the present disclosure relates to methods of manufacturing nutritional powders, including infant nutritional powders and adult nutritional powders, using ultrasonic energy.

### BACKGROUND OF THE DISCLOSURE

Powdered nutritional products, including both powdered infant formulas and powdered adult nutritional products, are widely commercially available and their use has grown steadily over the years. These products typically contain fat, carbohydrate, protein, vitamins, and minerals, and potentially other nutritionally beneficial components. Prior to use, the powdered formula or product is reconstituted in water at a predetermined ratio to produce a ready-to-drink liquid.

Conventionally, nutritional powders are produced using evaporation and spray drying methods. During the drying processes, the solids contents in the fluids (i.e., slurries) must be carefully monitored to ensure that the viscosity of the fluid remains low, preventing fouling and clogging of drying equipment. This requires a slower, longer evaporation and drying process, which can increase costs and reduce efficiency.

As such, there is a need in the art for efficient methods for producing nutritional powders. It would be advantageous if the slurries used for making the nutritional powders could be processed at a high solids content, resulting in a reduced evaporation and drying time. This would lead to a manufacturing process that has increased efficiency and reduced production costs. Further, it would be advantageous if the resulting nutritional powders could be produced to have high molecular weight components with increased solubility, further providing increased efficiency in processing of the powders and improved aesthetic properties of the resulting nutritional powders after reconstitution by the end user.

### SUMMARY OF THE DISCLOSURE

The present disclosure is directed to a process for manufacturing a nutritional powder. The process comprises: introducing an aqueous slurry comprising at least one of protein, carbohydrate, and fat into an evaporator, evaporating the aqueous slurry, wherein ultrasonic energy is applied before or during evaporation; and drying the evaporated aqueous slurry to produce the nutritional powder.

The present disclosure is further directed to a process for manufacturing a nutritional powder, the process comprising: heating an aqueous slurry comprising at least one of protein, carbohydrate, and fat; introducing the heated aqueous slurry into an evaporator; evaporating the heated aqueous slurry in a first evaporation effect to a total solids content of from about 45% to about 49% by weight; applying ultrasonic energy to the evaporated aqueous slurry; evaporating the ultrasonically-treated aqueous slurry to a total solids content of from 55% to about 65% by weight; and spray drying the evaporated aqueous slurry to produce the nutritional powder.

The present disclosure is further directed to a process for manufacturing a nutritional powder and to ultrasonically-produced nutritional powders manufactured using the process. The process comprises: applying ultrasonic energy to an aqueous slurry comprising at least one of protein, carbohydrate, and fat; evaporating the ultrasonic-treated aqueous slurry in an evaporator; and drying the evaporated aqueous slurry to produce the nutritional powder.

The present disclosure is further directed to an ultrasonically-produced nutritional powder prepared by the process of: introducing an aqueous slurry comprising at least one protein, carbohydrate, and fat into an evaporator; evaporating the aqueous slurry, wherein ultrasonic energy is applied during evaporation; and drying the evaporated aqueous slurry to produce the nutritional powder. The nutritional powder may be an infant nutritional powder or an adult nutritional powder. The infant nutritional powder comprises from about 10% to about 35% fat, from about 5% to about 35% protein, and from about 30% to about 85% carbohydrates, all by weight of the infant nutritional powder. The adult nutritional powder comprises from about 0.5% to about 20% fat, from about 10% to about 90% protein, and from about 5% to about 60% carbohydrates, all by weight of the adult nutritional powder.

It has been unexpectedly found that nutritional powders can be prepared utilizing ultrasonic energy such to allow evaporation at a higher solids level, thereby making the evaporation and drying processes more efficient.

It has been found that by subjecting an aqueous slurry typically used in making nutritional powders to ultrasonic energy before or during evaporation, the viscosity of the slurry is significantly reduced and the concentration of the solids in the slurry can be increased to improve overall efficiency. Significantly, the viscosity reduction of the slurry is carried through the evaporation process, allowing the evaporator to operate at increased solids and increasing the efficiency and production rate of the dryer.

It was further found that by subjecting the proteins in the slurry to ultrasonic energy, solubility of the high molecular weight proteins was increased. By increasing the solubility of these proteins, an increased solids content could be achieved in the resulting nutritional powder without the disadvantage of increasing the viscosity.

Further, by increasing the solubility of the high molecular weight proteins in the slurry, upon reconstitution, the nutritional powders had less sediment and separation, which is more aesthetically pleasing to the user. Moreover, the increased solubility will allow for improved digestibility of the high molecular weight proteins.

### BRIEF DESCRIPTION OF THE DRAWINGS

FIG. 1A is a chromatogram of reconstituted powder samples as analyzed in Example 2.

FIG. 1B is a chromatogram of reconstituted powder samples after pancreatin digestion as analyzed in Example 2.

FIG. 2 is a block diagram depicting one embodiment of a process for preparing the nutritional powders of the present disclosure.

FIG. 3 is a block diagram depicting one embodiment of a process for preparing the nutritional powders of the present disclosure.

### DETAILED DESCRIPTION OF THE DISCLOSURE

The ultrasonically-produced nutritional powders and corresponding manufacturing methods of the present disclosure are directed to infant and adult nutritional powders that have been prepared utilizing ultrasonic energy. These and other essential or optional elements or limitations of the powders and methods of the present disclosure are described in detail hereinafter.

The term “nutritional powders” as used herein includes both infant nutritional powders, adult nutritional powders, and nutritional powders generally.

The term “infant formula” as used herein includes both infant formulas and toddler formulas, wherein infant formulas are intended for infants up to about 1 year of age and toddler formulas are intended for children from about 1 year of age to about 10 years of age.

The term “adult nutritional product” as used herein includes formulas for generally maintaining or improving the health of an adult, and includes those formulas designed for adults who need to control their blood glucose.

The term “high molecular weight protein” as used herein refers to proteins or proteinaceous aggregates having a molecular weight of 20,000 Daltons or greater.

All percentages, parts and ratios as used herein, are by weight of the total formulation, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the ultrasonically-produced nutritional powders of the present disclosure may also be substantially free of any optional or selected essential ingredient or feature described herein, provided that the remaining powder still contains all of the required ingredients or features as described herein. In this context, and unless otherwise specified, the term “substantially free” means that the selected powder contains less than a functional amount of the optional ingredient, typically less than 0.1% by weight, and also including zero percent by weight of such optional or selected essential ingredient.

The nutritional powders and corresponding manufacturing methods of the present disclosure can comprise, consist of, or consist essentially of the essential elements and limitations of the disclosure as described herein, as well as any additional or optional ingredients, components, or limitations described herein or otherwise useful in nutritional applications.

### Product Form

The nutritional powders produced utilizing ultrasonic energy are typically in the form of flowable or substantially flowable particulate compositions, or at least particulate compositions. The compositions can easily be scooped and measured with a spoon or similar other device, and can easily be reconstituted by the intended user with a suitable aqueous liquid, typically water, to form a nutritional composition for immediate oral or enteral use. In this context, “immediate” use generally means within about 48 hours, most typically within about 24 hours, preferably right after reconstitution.

The nutritional powders may be reconstituted with water prior to use to a caloric density tailored to the nutritional needs of the ultimate user, although in most instances, when used as an infant nutritional powder, the powders are reconstituted with water to form compositions comprising at least 19 kcal/fl oz (660 kcal/liter), more typically from about 20 kcal/fl oz (675-680 kcal/liter) to about 25 kcal/fl oz (820 kcal/liter), even more typically from about 20 kcal/fl oz (675-680 kcal/liter) to about 24 kcal/fl oz (800-810 kcal/liter). Generally, the 22-24 kcal/fl oz formulas are more commonly used in preterm or low birth weight infants, and the 20-21 kcal/fl oz (675-680 to 700 kcal/liter) formulas are more often used in term infants. In some embodiments, the reconstituted powder may have a caloric density of from about 50-100 kcal/liter to about 660 kcal/liter, including from about 150 kcal/liter to about 500 kcal/liter. In some specific embodiments, the emulsion may have a caloric density of 25, or 50, or 75, or 100 kcal/liter.

When used as an adult nutritional powder, the powders are reconstituted with water to form compositions comprising from about 100 to about 500 kcal/240 ml, including from about 150 to about 350 kcal/240 ml, and also including from about 200 to about 320 kcal/240 ml.

The nutritional powders of the present disclosure may be formulated with sufficient kinds and amounts of nutrients so as to provide a sole, primary, or supplemental source of nutrition, or to provide a specialized nutritional formulation for use in individuals afflicted with specific diseases or conditions.

### Macronutrients

The nutritional powders of the present disclosure comprise at least one of fat, protein, and carbohydrate. Generally, any source of fat, protein, and carbohydrate that is known or otherwise suitable for use in powdered nutritional products may also be suitable for use in the nutritional powders herein, provided that such macronutrients are also compatible with the essential elements of the nutritional formulations as defined herein.

Although total concentrations or amounts of the fat, protein, and carbohydrates may vary depending upon the nutritional needs of the intended user, such concentrations or amounts most typically fall within one of the following embodied ranges, inclusive of any other essential fat, protein, and or carbohydrate ingredients as described herein.

### Carbohydrate

The ultrasonically-produced nutritional powders of the present disclosure may comprise a carbohydrate or carbohydrate source.

When the ultrasonically-produced nutritional powder is an infant nutritional powder, the carbohydrate component is present in an amount of from about 30% to about 85%, including from about 45% to about 60%, including from about 50% to about 55% by weight of the infant nutritional powder. The carbohydrate source may be any known or otherwise suitable source that is safe and effective for oral administration and is compatible with the essential and other ingredients in the powder.

When the ultrasonically-produced nutritional powder is an adult nutritional powder, the carbohydrate component is present in an amount of from about 5% to about 60%, including from about 7% to about 30%, including from about 10% to about 25%, by weight of the adult nutritional powder. The carbohydrate source may be any known or otherwise suitable source that is safe and effective for oral administration and is compatible with the essential and other ingredients in the powder.

Suitable carbohydrates or carbohydrate sources for use in the nutritional powders include glycerin, sucrose, dextrins, maltodextrin, tapioca maltodexrin, corn syrup, tapioca syrup, isomaltulose, lactose, fructose, both unhydroyzed, partially hydrolyzed gums, gum Arabic, also known as gum acacia, xanthan gum, gum tragacanth, and guar gum, glycerin, vegetable fibers, glucose, maltose, cooked and uncooked waxy and non-waxy corn starch, cooked and uncooked waxy and non-waxy tapioca starch, cooked and uncooked waxy and non-waxy rice starch, tagatose, galacto-oligosaccharides (GOS), fructo-oligosaccharides (FOS) including short chain, moderate length chain, and long chain fructo-oligosaccharides, alpha-lactose, beta-lactose, polydextrose, and combinations thereof.

Other suitable carbohydrates include any dietary fiber or fiber source, non-limiting examples of which include insoluble dietary fiber sources such as oat hull fiber, pea hull fiber, soy hull fiber, soy cotyledon fiber, sugar beet fiber, cellulose, corn bran, and combinations thereof.

The carbohydrate for use in the nutritional powders may therefore include soluble and/or insoluble fiber, or other complex carbohydrate, preferably having a DE (dextrose equivalent) value of less than about 40, including less than 20, and also including from 1 to 10.

### Fat

The ultrasonically-produced nutritional powders of the present disclosure may comprise a fat or fat source.

When the ultrasonically-produced nutritional powder is an infant nutritional powder, the fat component is present in an amount of from about 10% to about 35%, including from about 25% to about 30%, and including from about 26% to about 28% by weight of the infant nutritional powder. The fat may be any known or otherwise suitable source that is safe and effective for oral administration and is compatible with the essential and other ingredients in the powder.

When the ultrasonically-produced nutritional powder is an adult nutritional powder, the fat component is present in an amount of from about 0.5% to about 20%, including from about 1% to about 10%, and also including from about 2% to about 5% by weight of the adult nutritional powder. The fat may be any known or otherwise suitable source that is safe and effective for oral administration and is compatible with the essential and other ingredients in the powder.

Suitable fat or fat sources include coconut oil, soy oil, high oleic safflower or sunflower oil, safflower oil, sunflower oil, corn oil, palm oil, palm kernel oil, canola oil, triheptanoin, milk fat including butter, any animal fat or fraction thereof, fish or crustacean oils containing docosahexaenoic acid (DHA) and/or eicosapentaenoic acid (EPA), phospholipids from fish or crustacean containing docosahexaenoic acid (DHA) and/or eicosapentaenoic acid (EPA), concentrates of DHA and/or EPA from marine, vegetable, or fugal sources, arachidonic acid (ARA) concentrate from fungal or other sources, a-linolenic acid concentrate (ALA), flax seed oil, phospholipids and fractions thereof, including soy lecithin and egg lecithin, both partially hydrolyzed and unhydrolyzed, monoglycerides and/or diglycerides from both vegetable and animal sources, and plant sterols and compounds containing plant sterols, diacetyl tartaric acid of mono and diglycerides (DATEM) and combinations thereof.

### Protein

The ultrasonically-produced nutritional powders of the present disclosure may comprise a protein or protein source.

When the ultrasonically-produced nutritional powder is an infant nutritional powder, the protein component is present in an amount of from about 5% to about 35%, including from about 8% to about 12%, and including from about 10% to about 12% by weight of the infant nutritional powder. The protein may be any known or otherwise suitable source that is safe and effective for oral administration and is compatible with the essential and other ingredients in the powder.

When the ultrasonically-produced nutritional powder is an adult nutritional powder, the protein component is present in an amount of from about 10% to about 90%, including from about 30% to about 80%, and also including from about 40% to about 75% by weight of the adult nutritional powder. The protein may be any known or otherwise suitable source that is safe and effective for oral administration and is compatible with the essential and other ingredients in the powder.

Suitable protein or protein sources include either intact, partially hydrolyzed, or fully hydrolyzed, or a combination thereof, of lactase treated nonfat dry milk, milk protein isolate, milk protein concentrate, whey protein concentrate, glycomacropeptides, whey protein isolate, milk caseinates such as sodium caseinate, calcium caseinate, or any combination of caseinate salts of any mineral, soy protein concentrate, soy protein isolate, soy protein flour, pea protein isolate, pea protein concentrate, any monocot or dicot protein isolate or protein concentrate, animal collagen, gelatin, all amino acids, taurine, milk protein peptides, whey protein peptides, bovine colostrum, human colostrum, other mammalian colostrum, genetic communication proteins found in colostrum and in mammalian milk such as, but not limited to, interleukin proteins, hydrolyzed animal collagen, hydrolyzed yeast, and combinations thereof

### Macronutrient Profile

The total amount or concentration of fat, carbohydrate, and protein in the ultrasonically-produced nutritional powders of the present disclosure can vary considerably depending upon the selected formulation and dietary or medical needs of the intended user. Additional suitable examples of macronutrient concentrations are set forth below. In this context, the total amount or concentration refers to all fat, carbohydrate, and protein sources in the nutritional powder. For infant nutritional powders, such total amounts or concentrations are most typically and preferably formulated within any of the embodied ranges described in the following table (all numbers have “about” in front of them).

| Nutrient | | | |
|---|---|---|---|
| (% Calories) | Embodiment A | Embodiment B | Embodiment C |
| Carbohydrate | 20-85 | 30-60 | 35-55 |
| Fat | 5-70 | 20-60 | 25-50 |
| Protein | 2-75 | 5-50 | 7-40 |

For adult nutritional powders, such total amounts or concentrations are most typically and preferably formulated within any of the embodied ranges described in the following table (all numbers have “about” in front of them).

| Nutrient | | | |
|---|---|---|---|
| (% Calories) | Embodiment A | Embodiment B | Embodiment C |
| Carbohydrate | 1-98 | 10-75 | 30-50 |
| Fat | 1-98 | 20-85 | 35-55 |
| Protein | 1-98 | 5-70 | 15-35 |

### Optional Ingredients

The ultrasonically-produced nutritional powders of the present disclosure may further comprise other optional components that may modify the physical, chemical, aesthetic or processing characteristics of the powders or serve as pharmaceutical or additional nutritional components when used in the targeted population. Many such optional ingredients are known or otherwise suitable for use in medical food or other nutritional products or pharmaceutical dosage forms and may also be used in the powdered formulations herein, provided that such optional ingredients are safe and effective for oral administration and are compatible with the essential and other ingredients in the powders.

Non-limiting examples of such optional ingredients include preservatives, anti-oxidants, emulsifying agents, buffers, pharmaceutical actives, additional nutrients as described herein, vitamins, minerals, sweeteners including artificial sweeteners (e.g., saccharine, aspartame, acesulfame K, Stevia extract, and sucralose) colorants, flavorants in addition to those described herein, thickening agents and stabilizers, emulsifying agents, lubricants, probiotics (such as acidophilous and/or bifidus bacteria, both alive and inactive), prebiotics, beta-hydroxy beta-methylbutyrate (HMB), arginine, glutamine, and so forth.

Non-limiting examples of suitable minerals for use herein include phosphorus, sodium, chloride, magnesium, manganese, iron, copper, zinc, iodine, calcium, potassium, chromium, molybdenum, selenium, and combinations thereof.

Non-limiting examples of suitable vitamins for use herein include carotenoids (e.g., beta-carotene, zeaxanthin, lutein, lycopene), biotin, choline, inositol, folic acid, pantothenic acid, choline, vitamin A, thiamine (vitamin B₁), riboflavin (vitamin B₂), niacin (vitamin B₃), pyridoxine (vitamin B₆), cyanocobalamine (vitamin B₁₂), ascorbic acid (vitamin C), vitamin D, vitamin E, vitamin K, and various salts, esters or other derivatives thereof, and combinations thereof.

### Manufacture

The methods of the present disclosure incorporating the use of ultrasonic energy provide for ultrasonically-produced nutritional powders that can be prepared with evaporation at a higher solids content as compared to conventional spray dried nutritional powders, thereby increasing processing efficiency and reducing manufacturing costs. More particularly, by subjecting the aqueous slurries used in making nutritional powders to ultrasonic energy during manufacturing, and particularly, before or during evaporation, the viscosities of the slurries are significantly reduced and the concentration of the solids in the slurries can be increased to improve overall efficiency. Significantly, the viscosity reduction of the slurry is carried through the evaporation process, allowing the product to be evaporated at higher than typical solids levels. Further the ultrasonically-produced nutritional powders include high molecular weight proteins having an increased solubility, allowing for less sedimentation, separation and improved digestibility after reconstitution.

The nutritional powders of the present disclosure can therefore be prepared by any of a variety of known or otherwise effective formulation or manufacturing methods. In one suitable manufacturing process, for example, at least three separate slurries are prepared, including a protein-in-fat (PIF) slurry, a carbohydrate-mineral (CHO-MIN) slurry, and a protein-in-water (PIW) slurry. The PIF slurry is formed by heating and mixing the oil (e.g., DHA, canola oil, corn oil, etc.) and then adding an emulsifier (e.g., lecithin), fat soluble vitamins, and a portion of the total protein (e.g., milk protein concentrate, etc.) with continued heat and agitation. The CHO-MN slurry is formed by adding with heated agitation to water: minerals (e.g., potassium citrate, dipotassium phosphate, sodium citrate, etc.), trace and ultra trace minerals (TM/UTM premix), and thickening or suspending agents (e.g. avicel, gellan, carrageenan). The resulting CHO-MIN slurry is held for 10 minutes with continued heat and agitation before adding additional minerals (e.g., potassium chloride, magnesium carbonate, potassium iodide, etc.), and/or carbohydrates (e.g., HMOs, fructooligosaccharide, sucrose, corn syrup, etc.). The PIW slurry is then formed by mixing with heat and agitation the remaining protein, if any.

The resulting slurries are then blended together with heated agitation and the pH adjusted to 6.6-7.0, after which the composition is subjected to high-temperature short-time (HTST) processing during which the composition is heat treated, emulsified and homogenized, and then allowed to cool. In one embodiment, the composition is subjected to a heat treatment of ultra-high temperature (UHT) conditions. Water soluble vitamins and ascorbic acid are added, the pH is adjusted to the desired range if necessary, flavors are added, and water is added to achieve the desired total solids content.

The blended aqueous slurry is introduced into an evaporator. Typically, prior to evaporation, the aqueous slurry includes a total solids content of from about 15% by weight to about 40% by weight, including from about 20% by weight to about 40% by weight, and including from about 30% by weight to about 40% by weight.

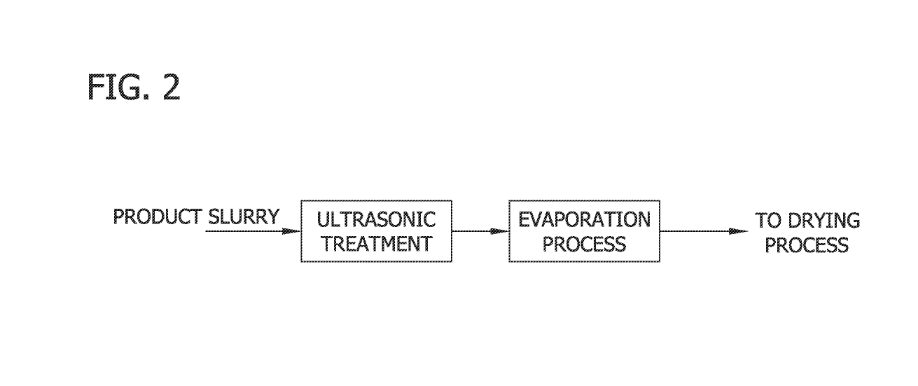

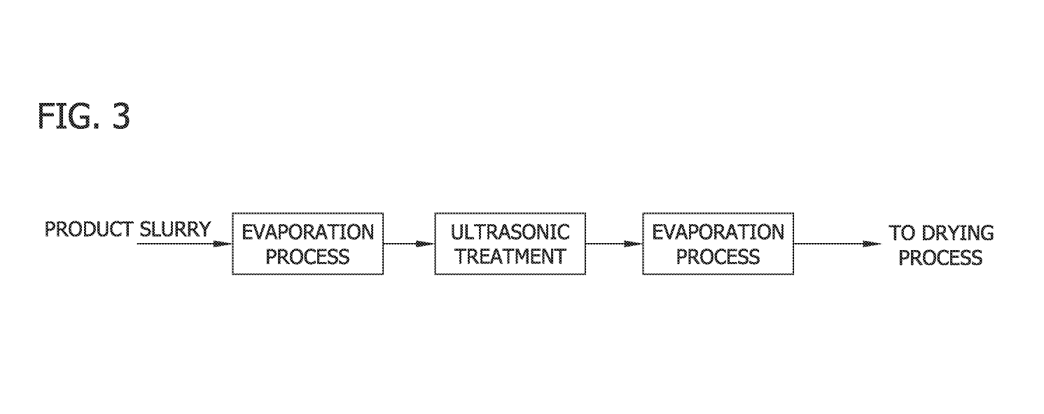

Prior to or during evaporation, ultrasonic energy is applied to the slurry. In one particularly preferred embodiment, as shown in the block diagram of FIG. 2, ultrasonic energy is applied continuously before evaporation of the aqueous slurry. In other suitable embodiments of the present disclosure, the aqueous slurry is evaporated in a multiple-effect evaporation process and ultrasonic energy is applied between the evaporation effects. For example, in one embodiment, as shown in the block diagram of FIG. 3, the aqueous slurry is evaporated in a first evaporator effect, treated with ultrasonic energy, and then further evaporated in a second or subsequent evaporation effect.

By way of example, an ultrasonic system includes a flow cell chamber having a cylinder with an interior diameter of about 2.5 inches and a length of about 8.2 inches. The aqueous slurry is introduced into the flow cell chamber at the bottom of the chamber at a flow rate of from about 1.0 gpm to about 1.4 gpm, including about 1.0 gpm to about 1.3 gpm, and including about 1.3 gpm, and a pressure of from about 10 psig to about 20 psig, including from about 12 psig to about 18 psig, and including about 17 psig. The ultrasonically-treated slurry is then discharged from the side of the chamber located near the top. It should be recognized by one skilled in the art, however, that the size and processing conditions of the flow cell chamber will depend on the scale of production.

The ultrasonic system typically includes a power generator, transducer, and sonotrode for applying ultrasonic energy. More particularly, a suitable ultrasonic system includes the power generator to provide energy to the transducer, which further energizes the sonotrode to mechanically vibrate ultrasonically. Examples of suitable ultrasonic systems include systems available from Hielscher Ultrasonics (e.g., UP400S, UIP1000hd) of Ringwood, N.J., and systems available from Sonics & Materials, Inc. of Newtown, Conn., Branson Ultrasonics of Danbury, Conn., and Industrial Sonomechanics of New York, N.Y.

The sonotrode is typically a cascade-type sonotrode having a diameter of about 2.25 inches and a length of about 7.5 inches. It should be understood by one skilled in the art, however, that any size or shape of ultrasonic sonotrode as suitable for use in making powders can be used by one skilled in the art without departing from the scope of the present disclosure.

In one embodiment, the ultrasonic system is capable of operating the sonotrode at about 50% to 100% amplitude, including from about 55% to about 90% amplitude and including about 75% amplitude and a frequency in the range of from about 15 kHz to about 100 kHz, including from about 15 kHz to about 50 kHz, and including about 20 kHz.

The viscosity of the aqueous slurry can be affected by the power level supplied by the ultrasonic system and the time period for which ultrasonic energy is contacted with the slurry. In one embodiment, the power generator provides the transducer and sonotrode power in the amount of at least about 75 watts, including from about 75 watts to about 16 kilowatts, including from about 75 watts to about 1000 watts, including from about 300 watts to about 800 watts, and including from about 380 watts to about 480 watts. The aqueous slurry is subjected to ultrasound for a period of from about 0.1 seconds to about 30 seconds, and including a period of from about 1 second to about 20 seconds. It should be understood by one skilled in the art, however, that the power level and time period used with the slurry may change depending on the size of the ultrasonic system used and the production rate desired.

After evaporation and application of ultrasonic energy, the aqueous slurry comprises a total solids content of at least 55% by weight, including from 55% to about 65% by weight, and including from about 59% to about 62% by weight total solids.

When evaporated using a multiple-effect evaporation process, the aqueous slurry may first be evaporated in a first evaporation effect to a total solids content of from about 40% by weight to about 49% by weight, including from about 45% to about 49% by weight, and including about 47% by weight total solids. The aqueous slurry may then be further evaporated in a second or further evaporation effect to a total solids content of at least 55% by weight, including at least 59% by weight, and including about 60% by weight total solids.

Once evaporated and ultrasonically treated, the methods of the present disclosure may further comprise the step of drying, such as by spray drying, the evaporated aqueous slurry to produce the nutritional powder.

The methods of the present disclosure allow for the use of aqueous slurries having a reduced viscosity while including a high solids content. This allows for greater efficiency and powder production rate and reduction of processing costs of the resulting ultrasonically-produced nutritional powders as increased evaporation is achieved prior to spray drying to form the powder. Typically, the ultrasonically-treated aqueous slurry produced by the methods of the present disclosure have a viscosity of at least 20%, including from 20% to about 50%, and including about 25%, lower than the viscosity of the aqueous slurry evaporated to a total solids content of at least 55% by weight without application of ultrasonic energy.

Further, the resulting ultrasonically-produced nutritional powders include high molecular weight components, and in particular, high molecular weight proteins, having increased solubility as compared to nutritional powders prepared without ultrasonic energy. In one embodiment, the ultrasonically-produced nutritional powders include high molecular weight proteins having a solubility of at least 1% greater, and including at least 5% greater, than high molecular weight protein in a nutritional powder prepared without ultrasonic energy. This increased solubility allows for improved texture and mouthfeel upon reconstitution of the powder by a user. Further, improved solubility of these components allows for increased digestibility by the user.

The present embodiments are to be considered in all respects as illustrative and not restrictive and that all changes and equivalents also come within the description of the present disclosure. The following non-limiting examples will further illustrate the ultrasonically-produced nutritional powders and methods of the present disclosure.

### EXAMPLES

The following examples illustrate specific embodiments and/or features of the ultrasonically-produced nutritional powders of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the nutritional powder, unless otherwise specified.

### Example 1

In this Example, a slurry including protein, carbohydrate and fat suitable for use in infant nutritional powders was evaporated to various solids content levels with and without the use of ultrasonic energy, and the viscosities of the various slurry samples were analyzed.

Two slurry samples were evaporated with application of ultrasonic energy, and two slurry samples were evaporated without application of ultrasonic energy. The two ultrasonically-treated samples were fed into a flow cell chamber at a flow rate of 1.0 gpm, a temperature of about 135° F. (57.2° C.), and a pressure of 17 psig. The ultrasonic system included a 1 kW-power unit, commercially available as Hielscher UIP1000hd (Hielscher Ultrasonics, Ringwood, N.J.), an ultrasound probe having a diameter of about 2.25 inches and a length 7.5 inches, and a flow cell chamber having a diameter of about 2.5 inches and a length of about 8 inches. The ultrasonic system was operated at a frequency of about 20 kHz with a booster of 1.8 in the down mode. The amplitude was set at 100% and the resulting power was 380 watts.

The total solids contents, after evaporation with and without the use of ultrasonic energy, and viscosities, measured as Brookfield viscosities, of the four slurry samples analyzed are shown in the table below.

| | | | Brookfield Viscosity | | |
|---|---|---|---|---|---|
| | Total | | | | Viscos- |
| | Solids | Temper- | Viscos- | | ity |
| | (% by | ature | ity | | Reduc- |
| Slurry Sample | weight) | (° F.) | (cps) | RPM | tion (%) |
| Slurry evaporated to 57.3% | 57.3 | 132 | 86 | 30 | NA |
| total solids content; no | | | | | |
| ultrasonic energy applied | | | | | |
| (trial 1) | | | | | |
| Slurry evaporated to 57.3% | 57.3 | 132 | 80 | 30 | NA |
| total solids content; no | | | | | |
| ultrasonic energy applied | | | | | |
| (trial 2) | | | | | |
| | | | Avg. 83 | | |
| Slurry evaporated to 57.9% | 57.9 | 129 | 54 | 30 | 35 |
| total solids content; | | | | | |
| ultrasonic energy applied at | | | | | |
| 48.6% total solids content | | | | | |
| (trial 1) | | | | | |
| Slurry evaporated to 57.9% | 57.9 | 129 | 77 | 30 | 7 |
| total solids content; | | | | | |
| ultrasonic energy applied at | | | | | |
| 48.6% total solids content | | | | | |
| (trial 2) | | | | | |
| | | | Avg. 66 | | 20 |

As shown in the table, by applying ultrasonic energy to the slurry during evaporation to a total solids content of 57.9% by weight, viscosity can be reduced.

### Example 2

In this Example, three infant nutritional powders were prepared with and without the application of ultrasonic energy during evaporation. The resulting nutritional powders, as reconstituted in water, were analyzed for molecular weight profile before and after pancreatin digestion.

Slurries including protein, fat, and carbohydrate suitable for use in an infant nutritional powder were prepared. A control sample (CON61 R4V2) was first prepared by processing the slurry to a 36% by weight total solids content using a HTST process, homogenization, and cooling. The slurry was standardized with vitamins and minerals. The slurry was heated using a UHT process then continuously pumped into an evaporator where the slurry was evaporated to 58% by weight total solids content and spray dried into a powder.

A sample (US61 R4V5) was prepared by processing the individual slurry to a 36% by weight total solids content using a HTST process, homogenizing, and cooling. The slurry was standardized with vitamins and minerals. The slurry was heated using an UHT process and continuously pumped into an evaporator feed kettle and through the flow cell chamber of an UIP1000hd ultrasonic system (available from Hielscher Ultrasonics, Ringwood, N.J.) without any booster. The slurry was fed through the flow cell chamber at a product flow rate of 1.3 gpm with 10 psig of back pressure. The amplitude was set at 75% and the power draw was about 790 watts. The slurry was then evaporated to 59% by weight total solids content and then spray dried into a powder.

A sample (EUS65 R4V9) was prepared by processing the individual slurry to a 36% by weight total solids content using a HTST process, homogenizing and cooling. The slurry was standardized with vitamins and minerals. The slurry was heated using an UHT process and evaporated to 45% by weight total solids content. The evaporated slurry was then fed through the flow cell chamber of an UIP1000hd ultrasonic system (available from Hielscher) without any booster. The slurry was fed through the flow cell chamber at a product flow rate of 1.3 gpm with 10 psig of back pressure. The amplitude was set at 55% and the power draw was about 480 watts. The slurry was then further evaporated to 62% by weight total solids content and then spray dried into a powder.

The powders were reconstituted and compared by molecular weight profile analysis using Superdex Peptide HPLC. The reconstituted powders were tested both before and after pancreatin digestion. The molecular weight median values are compared in the table below.

| | MW median of | MW median of |
|---|---|---|
| | pancreatin undigested | pancreatin digested |
| Sample | reconstituted powder | reconstituted powder |
| CON61 R4V2 | 16,223 Daltons | 1200 Daltons |
| US61 R4V5 | 16,408 Daltons | 1188 Daltons |
| EUS65 R4V9 | 16,420 Daltons | 1149 Daltons |

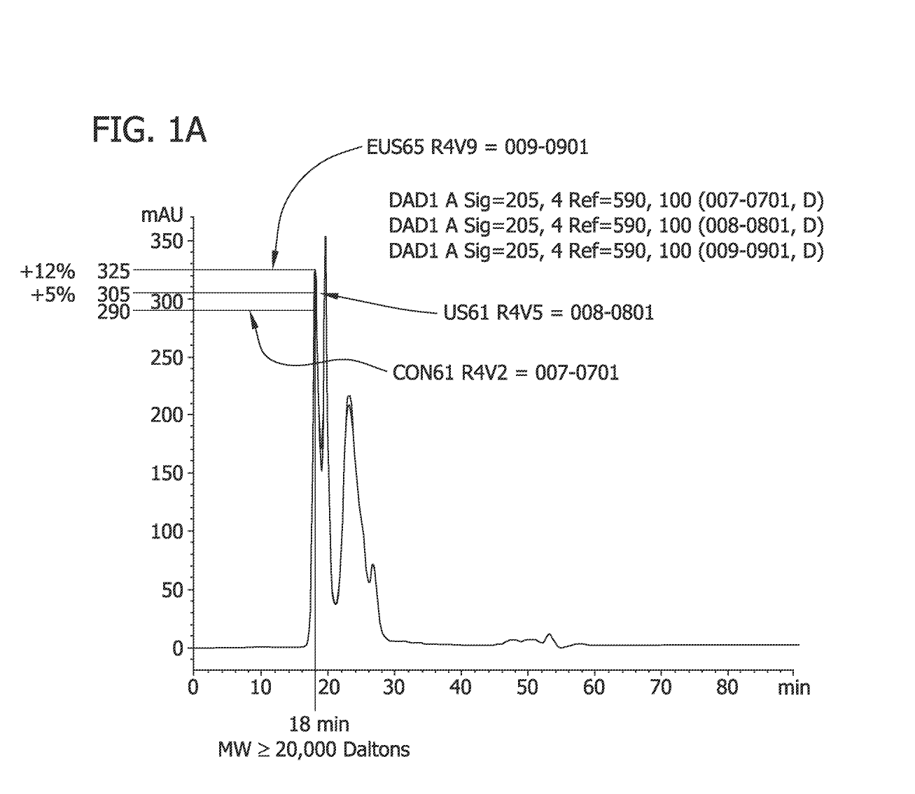

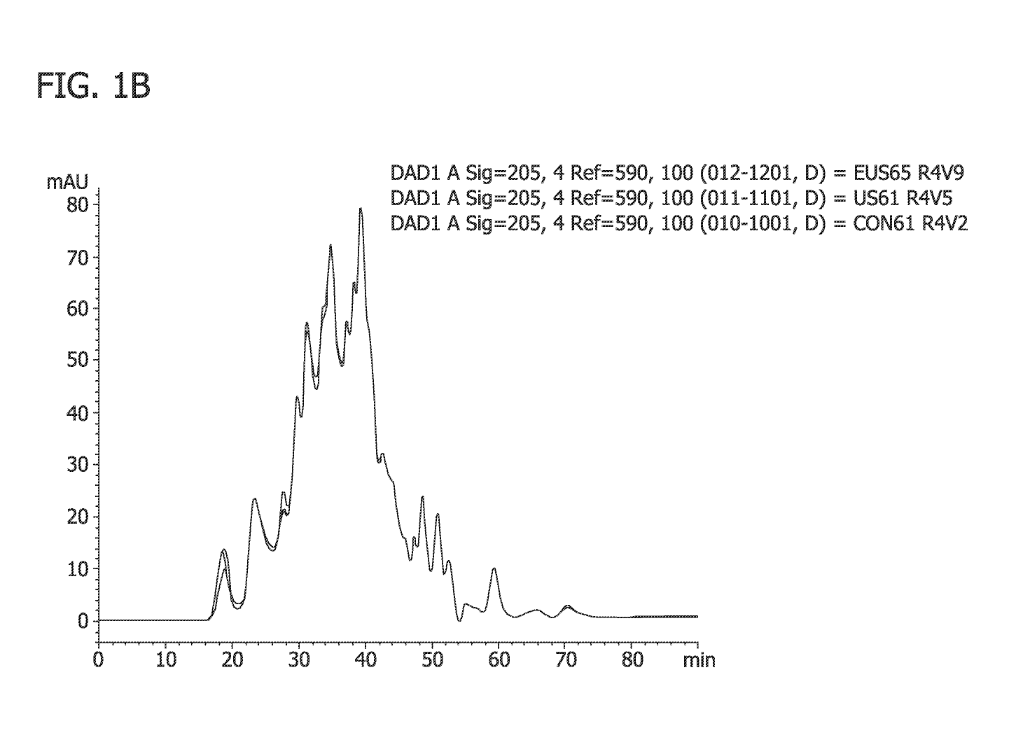

The higher molecular weight median values measured for the reconstituted ultrasonically-treated powders (US61 R4V5 and EUS65 R4V9) suggest that the ultrasonic treatment enhanced solubilization of high molecular weight proteins in the aqueous slurries. This is further depicted in the chromatogram of FIG. 1A.

The pancreatin digestion was conducted in order to compare protein digestibility. The chromatogram of FIG. 1B shows the close similarity among the digested samples. Further, as the molecular weight median values of the digested ultrasonically-treated powders were lower than that of the digested control powders, it appears unlikely that the ultrasonic treatment adversely affected protein quality, i.e., there was no indication that the ultrasonic treatment impaired protein digestibility.

### Example 3

In this Example, two of the slurry samples from Example 2 were analyzed for viscosity prior to spray drying.

Particularly, the viscosity of CON61 R4V2 evaporated to 58% by weight total solids content was compared to US61 R4V5 ultrasonically-treated and then evaporated to 59% by weight total solids content. The viscosities were measured using ARES LS1 with concentric cylinder geometry (available from TA Instruments, New Castle, Del.). The results are shown in the following tables.

| | | | | |
|---|---|---|---|---|
| | | Viscosity | Rate | Temperature |
| Sample | Time (s) | (cps) | (s⁻¹) | (° F.) |

CON61 R4V2

| | | | | |
|---|---|---|---|---|
| 1 | 35 | 92.27 | 2000.00 | 135.00 |
| 2 | 60 | 91.17 | 1782.50 | 135.13 |
| 3 | 84 | 91.67 | 1588.66 | 135.22 |
| 4 | 108 | 93.07 | 1415.89 | 135.25 |
| 5 | 129 | 94.79 | 1261.91 | 135.23 |
| 6 | 156 | 96.86 | 1124.68 | 135.18 |
| 7 | 180 | 99.22 | 1002.37 | 135.12 |
| 8 | 203 | 101.92 | 893.367 | 135.06 |
| 9 | 227 | 105.00 | 796.214 | 135.01 |
| 10 | 250 | 107.56 | 709.627 | 134.97 |
| 11 | 274 | 110.58 | 632.455 | 134.94 |
| 12 | 298 | 106.47 | 563.677 | 134.92 |
| 13 | 319 | 107.11 | 502.377 | 134.91 |
| 14 | 343 | 105.26 | 447.744 | 134.91 |
| 15 | 365 | 105.56 | 399.052 | 134.91 |
| 16 | 389 | 106.98 | 355.656 | 134.91 |
| 17 | 413 | 108.14 | 316.979 | 134.92 |
| 18 | 436 | 109.35 | 282.507 | 134.93 |
| 19 | 459 | 110.32 | 251.785 | 134.95 |
| 20 | 481 | 111.55 | 224.404 | 134.96 |
| 21 | 505 | 113.08 | 200.00 | 134.96 |
| 22 | 531 | 114.09 | 178.250 | 134.97 |
| 23 | 567 | 116.22 | 158.866 | 134.98 |
| 24 | 591 | 117.69 | 141.589 | 134.99 |
| 25 | 616 | 118.82 | 126.191 | 134.98 |
| 26 | 639 | 120.10 | 112.468 | 134.99 |
| 27 | 666 | 121.56 | 100.237 | 134.99 |

US61 R4V5

| | | | | |
|---|---|---|---|---|
| 1 | 35 | 69.60 | 2000.00 | 135.01 |
| 2 | 60 | 67.01 | 1782.50 | 135.14 |
| 3 | 84 | 66.44 | 1588.66 | 135.22 |
| 4 | 108 | 66.71 | 1415.89 | 135.23 |
| 5 | 129 | 67.21 | 1261.91 | 135.20 |
| 6 | 156 | 67.76 | 1124.68 | 135.15 |
| 7 | 180 | 68.48 | 1002.37 | 135.09 |
| 8 | 203 | 69.26 | 893.367 | 135.04 |
| 9 | 227 | 71.01 | 796.214 | 135.00 |
| 10 | 250 | 71.91 | 709.627 | 134.96 |
| 11 | 274 | 73.15 | 632.455 | 134.93 |
| 12 | 298 | 74.87 | 563.677 | 134.93 |
| 13 | 319 | 75.82 | 502.377 | 134.92 |
| 14 | 343 | 76.65 | 447.744 | 134.93 |
| 15 | 365 | 78.79 | 399.052 | 134.94 |
| 16 | 389 | 85.31 | 355.656 | 134.96 |
| 17 | 413 | 86.17 | 316.979 | 134.97 |
| 18 | 436 | 87.20 | 282.507 | 134.97 |
| 19 | 459 | 88.16 | 251.785 | 134.98 |
| 20 | 481 | 89.60 | 224.404 | 134.99 |
| 21 | 505 | 91.03 | 200.00 | 135.00 |
| 22 | 531 | 92.28 | 178.250 | 135.00 |
| 23 | 567 | 93.88 | 158.866 | 134.99 |
| 24 | 591 | 95.59 | 141.589 | 134.99 |
| 25 | 616 | 97.32 | 126.191 | 134.98 |
| 26 | 639 | 99.11 | 112.468 | 134.97 |
| 27 | 666 | 100.96 | 100.237 | 134.98 |

As shown in the tables above, US61 R4V5 showed reduction in viscosity as compared to CON61 R4V2 in a range of about 17-34% over the range of shear rates of from 100 s⁻¹ to 2000 s⁻¹.

What is claimed is:

1. A process for manufacturing a nutritional powder, the process comprising:
introducing an aqueous slurry comprising at least one of protein, carbohydrate, and fat into an evaporator;
evaporating the aqueous slurry, wherein ultrasonic energy is applied during evaporation; and
drying the evaporated aqueous slurry to produce the nutritional powder.

2. The process of claim 1, wherein the aqueous slurry comprises a total solids content prior to evaporation of from about 30% by weight to about 40% by weight.

3. The process of claim 1, wherein the aqueous slurry comprises a total solids content after evaporation of at least 55% by weight.

4. The process of claim 1, wherein the ultrasonic energy is applied at a frequency of from about 15 kHz to about 50 kHz.

5. The process of claim 1, wherein the ultrasonic energy is applied in an amount of from about 75 watts to about 16 kilowatts for a time period of from about 0.1 seconds to about 30 seconds.

6. A process for manufacturing a nutritional powder, the process comprising:
heating an aqueous slurry comprising at least one of protein, carbohydrate, and fat;
introducing the heated aqueous slurry into an evaporator;
evaporating the heated aqueous slurry in a first evaporation effect to a total solids content of from about 45% to about 49% by weight;
applying ultrasonic energy to the evaporated aqueous slurry;
evaporating the ultrasonically-treated aqueous slurry to a total solids content of from 55% to about 65% by weight; and
spray drying the evaporated aqueous slurry to produce the nutritional powder.

7. The process of claim 6, wherein the aqueous slurry comprises a total solids content prior to evaporation of from about 30% by weight to about 40% by weight.

8. The process of claim 6, wherein the aqueous slurry comprises a total solids content after evaporation of at least 59% by weight.

9. The process of claim 6, wherein the ultrasonic energy is applied at a frequency of from about 15 kHz to about 50 kHz.

10. The process of claim 6, wherein the ultrasonic energy is applied in an amount of from about 75 watts to about 16 kilowatts for a time period of from about 0.1 seconds to about 30 seconds.

11. A process for manufacturing a nutritional powder, the process comprising:
applying ultrasonic energy to an aqueous slurry comprising at least one of protein, carbohydrate, and fat;
evaporating the ultrasonic-treated aqueous slurry in an evaporator; and
drying the evaporated aqueous slurry to produce the nutritional powder.

12. The process of claim 11, wherein the aqueous slurry comprises a total solids content prior to evaporation of from about 30% by weight to about 40% by weight.

13. The process of claim 11, wherein the aqueous slurry comprises a total solids content after evaporation of at least 55% by weight.

14. The process of claim 11, wherein the ultrasonic energy is applied at a frequency of from about 15 kHz to about 50 kHz.

15. An ultrasonically-produced nutritional powder prepared by the process of:
introducing an aqueous slurry comprising at least one of protein, carbohydrate, and fat into an evaporator;
evaporating the aqueous slurry, wherein ultrasonic energy is applied during evaporation; and
drying the evaporated aqueous slurry to produce the nutritional powder.
